(19) United States
(12) Patent Application Publication
(10) Pub. No.: US 2002/0096254 A1
(43) Pub. Date: Jul. 25, 2002

(54) Optical device module and method of fabrication

(76) Inventors: Michael Kober, Glonn (DE); Michael E. Wernle, Hohenkirchen (DE); Herbert J. Neuhaus, Colorado Springs, CO (US)

Correspondence Address: DORSEY & WHITNEY, LLP, SUITE 4700, 370 SEVENTEENTH STREET, DENVER, CO, 80202-5647, US

(21) Appl. No.: 10/053,664

(22) Filed: Jan. 18, 2002

Related U.S. Application Data
(60) Provisional application No. 60/263,324, filed on Jan. 22, 2001.

(51) Int. Cl. B32B 31/00

(52) U.S. Cl. 156/307.3; 156/64

(57) ABSTRACT

An optical device module, for example, an LED array module or photosensor module, includes a plurality of optical devices electrically attached to contact lands on a substrate by a plurality of electrically conductive hard particles and mechanically attached by a non-electrically conductive bonding adhesive. The optical device module may further include a cover that is transparent to the light emitted or detected by the optical devices and that has electrically conductive contact pads on an inner surface thereof, which are bonded to bond pads on a face surface of the optical devices. A process for fabricating an optical device module includes electrically connecting the optical device to the electrical contact land on the substrate by attaching a plurality of electrically conductive hard particles to either the base surface of the optical device or to the electrical contact lands. An adhesive is applied to one of the mounting substrate or a contact land overlying the substrate or both, and the optical device is placed on the contact land and the adhesive is cured.

### CROSS REFERENCE TO RELATED APPLICATIONS

This application claims the benefit of priority of U.S. Provisional application serial No. 60/263,234 filed Jan. 22, 2001, entitled “Method to Assemble LED Arrays,” which is hereby incorporated herein by reference.

### BACKGROUND OF THE INVENTION

1) Field of the Invention

This invention relates, generally, to optical device modules and, more particularly, to illuminating device array modules, such as light-emitting-diode (LED) array modules and optical sensor modules, such as photosensor modules, and to methods for fabricating optical device modules.

2) Description of Related Art

Many public buildings and access ways are now provided with continuous illumination devices and optical sensing devices to improve the safety of public thoroughfares and building entrances and exits. Further, many different kinds of displays are used in which continuous illumination or optical sensing is necessary. For the most part, incandescent lightbulbs are used as the light source for lighting systems and displays. Because of the relatively short lifetime of incandescent bulbs, these bulbs must be frequently replaced in illuminating devices and displays in continuous operation. In addition to cost considerations, frequent replacement of incandescent bulbs and optical sensors can be difficult where the device module is located in a remote location, for example, at ceiling level in large rooms and in elevated display panels.

One solution to the frequent maintenance problem of incandescent display units is to replace the incandescent bulbs with light-emitting diodes. Arrays of light-emitting diodes (“LED”s) can be used as a replacement for incandescent lightbulbs. Because the LEDs do not “burn out,” these devices offer significant advantages in improved reliability and reduced maintenance cost. In addition, LED arrays use less power, which reduces operating costs in comparison to illuminating devices containing incandescent lightbulbs.

A typical LED array can range in size from about 300 microns×300 microns up to about 30 mm×30 mm. Because of their relatively small size, a large number of individual LEDs are required in an array to provide sufficient light intensity. For example, one array may contain as many as about 8,000 LEDs. The modules can also include other optical devices, for example, optical sensors and photosensors. The individual LEDs are packed tightly in the array, such that the separation distance between individual LEDs may be on the order of about 30 microns to about 350 microns, and the pitch spacing may vary from about 50 microns to about 500 microns. The large number of LEDs required for sufficient illumination, coupled with the need to tightly pack the individual LEDs together in an array, makes the fabrication of LED array modules difficult. Additionally, in many existing LED array modules, each individual LED is bonded to a substrate with a conductive adhesive or solder and then, in a separate operation, each LED is wire-bonded to make an electrical connection between the LED and the substrate. The necessity of making an electrical contact at the upper and lower surfaces of each LED works to increase the amount of substrate surface area necessary for mounting an LED array. Accordingly, the spatial illumination intensity is not optimum because of the relatively large spacing between each individual LED.

Both of the widely used device bonding techniques, solder and conductive adhesives, limit the spatial density and increase manufacturing cost. Traditional soldering technology, as modified for direct chip mounting, represents one of the most widely used chip bonding techniques. Often eutectic Pb/Sn, such as Pb/Sn 37/63, is used for the bumping and connection process. Although solder bonding is widely used, the relatively high temperatures of the soldering process limits the substrate materials to extremely high grade, high cost materials—not a favorable condition for large volume manufacturing. In addition, recent changes in legislation addressing environmental and health concerns in the European Union, Japan, and the U.S. prescribe the use of lead-free soldering materials, which usually require considerably higher processing temperatures or more expensive solders. Also, the preparation of a solderable metalization surface on the substrate before soldering and a cleaning step after bonding are usually necessary, which increase the complexity and the cost of the process. Often, underfilling the chip is also necessary, which is an added, time-consuming step that increases production cost.

In addition to restricting the packing density of the LEDs in an array, the use of conductive adhesives to bond each LED to the substrate can cause electrical shorts between adjacent LEDs. During the assembly process, the conductive adhesive can run between adjacent bond pads creating an electrical pathway. The need to prevent shorting between adjacent LEDs is typically addressed by increasing the spacing between the LEDs, thus further limiting the density of the array. In addition to the potential for electrical shorts, the poor thermal conductivity of most commonly used electrically conductive adhesives can result in excessive heat build-up within an LED module. The most common means of addressing the problem of excessive heat build-up is to increase the spacing between adjacent LEDs, again limiting the effective array density.

Current methods for assembling LED arrays and optical device modules suffer from other problems in addition to those described above. For example, conductive adhesive is expensive and requires long processing times to properly cure the adhesive. Additionally, gold metallization is often required on a substrate contact land to produce a reliable electrical contact with the conductive adhesive, further increasing assembly costs. Moreover, when used as an illuminating display or an optical sensing device, the optical module generally must be sealed. The sealing step is typically performed as a separate operation from the optical device attachment and bonding operation. The need to perform numerous, separate processing operations further increases the costs of production. Accordingly, a need exists for an improved optical device module and an improved process for fabricating an optical device module.

### SUMMARY OF THE INVENTION

The present invention provides an optical device module and a process for fabricating the module that do not require the use of conductive adhesives, and in some embodiments, do not require the use of wire-bond technology. In accordance with one embodiment of the invention, a mounting substrate is provided having an electrical contact land on a surface of the mounting substrate. An optical device, such as an LED or photosensor, is provided that has an electrically conductive base surface opposite a face surface, wherein the face surface includes an electrical contact, referred to herein as a bond pad. The optical device is bonded to the electrical contact land on the mounting substrate by attaching a plurality of electrically conductive hard particles to the base surface of the optical device or to the electrical contact land and applying an adhesive, which may be a non-electrically-conductive adhesive, to either the base surface or the contact land. The base surface of the optical device is then brought into contact with the contact land of the mounting substrate to create an electrical connection and the adhesive is cured.

In another embodiment, a flip-chip bonding process includes electrically connecting an optical device with multiple bond pads on its face surface to corresponding multiple electrical contact lands on the subtrate. The optical device is electrically connected to the electrical contact lands on the mounting substrate by attaching a plurality of electrically conductive hard particles to either the bond pads on the face surface of the optical device or to the electrical contact lands. Mechanical attachment is facilitated by positioning an adhesive, which may be a non-electrically-conductive adhesive, between the face surface of the optical device and the substrate.

The electrically conductive hard particles may be metal particles, for example, of copper, aluminum, nickel, tin, bismuth, silver, gold, platinum, palladium, lithium, beryllium, boron, sodium, magnesium, potassium, calcium, gallium, germanium, rubidium, strontium, indium, antimony, cesium, and barium, and alloys and intermetallics of these metals. The electrically conductive hard particles of the present invention may have a hard, non-conductive core surrounded by any of the metals set forth above. The hard, non-conductive cores may be composed of, for example, diamond, garnet, ceramic, oxides, suicides, silicates, carbides, carbonates, borides, boron fibers, and nitrides.

The hard particles provide several advantages for connection of the optical devices over prior techniques. Because the hard particles provide the electrical connection between the optical devices and the substrate, an electrically conductive adhesive is not required to bond the optical devices to the substrate. Therefore, the optical devices may be arranged in closer proximity without concern for electrical shorting from electrically conductive adhesive running together. The hard particles may be chosen to provide increased heat transfer capacity for the optical devices, thereby allowing the optical devices to be placed closer together. For example, hard particles with a diamond core provide exceptional heat transfer capabilities, as diamond has one of the highest coefficients of heat transfer of any substance. Closer spacing of the optical devices, without increasing heat retention, provides for higher intensity light output by the optical device modules.

In accordance with the invention, the use of electrically conductive hard particles to form the attachment permits the use of a non-electrically-conductive adhesive, for example, a non-electrically-conductive adhesive having a low thermal resistance to physically attach the optical device to the contact land on the mounting substrate. Suitable non-electrically-conductive adhesives may include, but are not limited to, for example, cyanoacrylate, epoxy-based adhesives, polyurethane-based adhesives, and UV-curable adhesives. In contrast with electrically conductive adhesive, the non-electrically-conductive adhesives for use with the present invention may be chosen to provide significantly higher heat dissipation and transfer of the heat generated by the optical devices. When the use of non-electrically conductive adhesives is combined with the strong heat transfer properties of the hard particle connections, the optical devices may be placed substantially closer together, thus increasing the concentration of light output that may be provide by a module.

In addition to enabling the use of non-electrically-conductive adhesives, the process of the invention also enables copper or aluminum metallization, for example, to be used on the electrical contact lands, rather than a precious metal, for example, gold that does not oxidize. These metals may be used because the electrically conductive hard particles pierce through the adhesive and any surface oxidation or other interfering residues (e.g., dirt, oil) on the electrical contacts of either or both the mounting substrate and the optical device, to ensure a robust electrical connection.

In one embodiment, the electrically conductive hard particles are attached to the base surface of the optical device by placing the electrically conductive base surface in contact with the hard particles and applying a compressive force, such that the hard particles adhere to the base surface. The term “adhere” as used herein, is meant in its broad sense of holding or sticking by any means, for example, gluing, suction, fusing, embedding, electrostatic forces, and van der Walls forces, and is not to be limited to the use of adhesive. Then, the adhesive is applied to the contact land, the base surface of the optical device is placed on the contact land, and the adhesive is cured. In another embodiment of the invention, the electrically conductive hard particles are applied to one of the contact land and the optical device. The optical device is then pressed on to the contact land to form an electrical connection between the device and substrate.

In another embodiment of the invention, a process for fabricating an optical device module includes providing a substrate having a plurality of optical devices mounted on the substrate. The optical devices may be mounted on the substrate using the process of the invention described above. Further, the optical devices may be an array of undiced optical devices on a portion of a wafer, where the entire wafer portion is mounted on the substrate. Each optical device has at least one bond pad on the face surface of the device. A cover is provided that has electrically conductive contact pads on an inner surface of the cover. The cover is constructed of a material that is transparent to light emitted or detected by the optical device. A plurality of electrically conductive hard particles are positioned on either the contact pads or the bond pad on the optical device. The hard particles are positioned such that each of the electrical contact pads or bond pads has at least one hard particle associated therewith. Then, a layer of adhesive is applied on at least the face surface of the optical device or on the inner surface of the cover. The adhesive is composed of a material that is substantially transparent to the light emitted or detected by the optical devices. Once the adhesive is applied, the contact pads are bonded to the bond pads.

By directly bonding a transparent cover to bond pads on the optical devices, the need to provide package leads, for example, wire bonds, is removed. Since package leads are not needed, an optical device module fabricated in accordance with the invention does not suffer from potential shorting as the devices are positioned in close proximity to one another. Accordingly, in this embodiment of the invention, an LED array may include a plurality of closely packed optical devices, resulting in LED arrays requiring a small surface area and that provide high-intensity illumination.

In addition to providing high-density optical device arrays, an optical device module fabricated in accordance with the invention, can be sealed in a single step. Since package leads, for example, wire bonds, are not necessary, all the connections to the bond pads of each device can be made at the time the cover is attached to the module. Further, as a non-electrically-conductive adhesive may be used, an adhesive can be chosen to act not only as the mechanical bond between the optical device and the cover and substrate, but also to act as the sealing material for the entire covered module. Accordingly, an optical device module fabricated in accordance with the invention benefits from reduced product costs compared with optical device modules of the prior art.

The electrically conductive contact pads on the cover can be interconnected by metal traces positioned on the cover such that, when the contact pads are bonded to the bond pads, the cover is free of traces directly overlying each of the plurality of optical devices. In this way, the metal traces do not block the light emitted or detected by the devices during the operation of the module.

In another embodiment of the invention, the cover is provided having an electrically conductive layer overlying an inner surface of the cover. The electrically conductive layer is substantially transparent to the light emitted or detected by the optical devices.

In yet another embodiment of the invention, the cover can further include a plurality of lenses positioned on a side opposite the electrically conductive contact pads. Each of a plurality of lenses is positioned on the cover, such that each lens is in a spaced relationship with one or more of a plurality of LEDs. The lenses serve to magnify the light emitted by the LEDs, thus increasing the output intensity of the LED array module.

### BRIEF DESCRIPTION OF THE DRAWINGS

FIG. 1 illustrates, in cross-section, a portion of a substrate having an illuminating device mounted thereto in accordance with the invention.

FIGS. 2-5 illustrate, in cross-section, processing steps in accordance with the invention for bonding an illuminating device to a substrate.

FIG. 6 illustrates an exploded cross-sectional view of a flip-chip bonding process in accordance with the invention.

FIG. 7 illustrates, in cross-section, a portion of an illuminating device array module arranged in accordance with the invention.

FIG. 8 illustrates a perspective view of an illuminating device array module assembly in accordance with the invention.

It will be appreciated that, for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION OF THE INVENTION

Shown in FIG. 1 is a cross-sectional view of an optical device 10 bonded to a substrate 12 in accordance with one embodiment of the invention. The illuminating device 10 may be any of a number of different kinds of optical devices, for example, an LED, an optical sensor, and a photosensor. Further, the substrate 12 can be one of a number of electrical component mounting substrates, for example, a flexible chip carrier, a printed circuit board, a flexible lead frame tape, and a ceramic substrate. The optical device 10 is bonded to an electrical contact land 14 residing on a surface 16 of the substrate 12. An electrical contact between a base surface 18 of the optical device 10 and the electrical contact land 14 is made by a plurality of electrically conductive hard particles 20 and an adhesive layer 22. The adhesive layer 22 serves to aid in the mechanical attachment of the illuminating device 10 to the substrate 12. In a preferred embodiment of the invention, the adhesive layer 22 is a non-electrically conductive adhesive, for example, cyanoacrylate, an epoxy-based adhesive, a polyurethane-based adhesive, or a UV-curable adhesive. In an important aspect of the invention, the use of electrically conductive hard particles 20 to form an electrical connection between the optical device 10 and the electrical contact land 14 enables the use of a non-electrically conductive adhesive in the present invention.

In accordance with the invention, the electrically conductive hard particles 20 can be hard particles formed from a metal or hard intermetallic material. The electrically conductive hard particles may be metal particles, for example, of copper, aluminum, nickel, tin, bismuth, silver, gold, platinum, palladium, lithium, beryllium, boron, sodium, magnesium, potassium, calcium, gallium, germanium, rubidium, strontium, indium, antimony, cesium, and barium, and alloys and intermetallics of these metals. The electrically conductive hard particles of the present invention may have a hard, non-conductive core surrounded by any of the metals set forth above. The hard, non-conductive cores may be composed of, for example, diamond, garnet, ceramic, oxides, silicides, silicates, carbides, carbonates, borides, boron fibers, and nitrides. In a preferred embodiment of the invention, electrically conductive hard particles 20 are composed of a diamond core plated with a layer of nickel.

A face surface 24 of the optical device 10 resides opposite the base surface 18 and includes a bond pad 26. In accordance with one embodiment of the invention, a wire bond 28 is attached to the bond pad 26 on the face surface 24 and to a metal lead 29 overlying the surface 16 of the substrate 12. In operation, the optical device 10 may be activated by an electrical impulse, a constant electrical current, or both transmitted to the optical device 10 through the wire bond 28. When the optical device 10 is an LED, the optical device 10 will emit light when activated from a p-n junction 30 within the illuminating device 10. Although only one such device is illustrated in FIG. 1, those skilled in the art will appreciate that an array of optical devices, such as an LED array, will include numerous devices, typically arranged in a regular array on substrate 12.

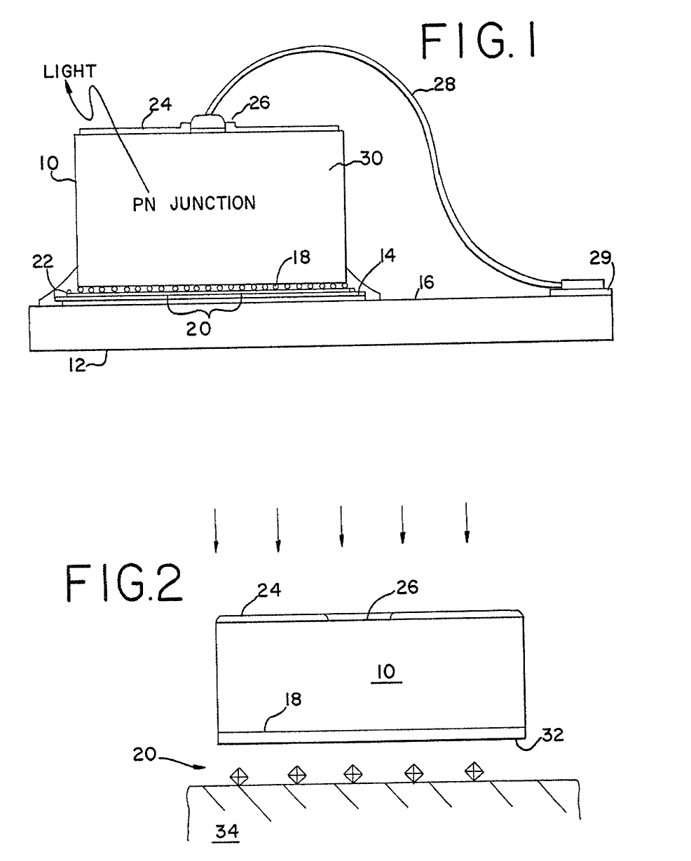

FIGS. 2-5 illustrate processing steps in accordance with the invention for the bonding of the optical device 10 to the substrate 12. Although the following description is set forth in the context of the bonding of a single optical device 10 to a substrate 12, those skilled in the art will recognize that a typical optical device array will include numerous optical devices 10 that may be arranged in a variety of geometric configurations on the surface of a substrate 12. The process of the invention may be used to populate any of the substrates 12 described above with numerous optical devices 10.

In one embodiment of the invention, as illustrated in FIG. 2, the optical device 10 includes a metal layer 32 overlying the base surface 18. The metal layer 32 is preferably a soft, deformable metal, for example, gold. Electrically conductive hard particles 20 are disposed on a support surface 34. Although the electrically conductive hard particles 20 are illustrated as singularly spread across the support surface 34, the electrically conductive hard particles 20 can also be arranged within a containment vessel or reservoir and be randomly disposed within the containment vessel to a depth of several millimeters or more.

After bringing the optical device 10 into proximity with the electrically conductive hard particles 20, a compressive force is applied in a direction normal to the support surface 34 so that the hard particles 20 adhere to the base surface 18. When adhering the hard particles 20 to the base surface 18, the hard particles 20 may at least partially penetrate the metal layer 32. Those skilled in the art will appreciate that the magnitude of the compressive force will depend upon the nature of the adhesive attachment force. Further, the magnitude of the adhesion force may depend upon the hardness and surface texture of the metal layer 32 and the particular structure of the electrically conductive hard particles 20. For example, the amount of compressive force will increase where the metal layer 32 is a relatively hard metal. In general, the hard particles 20 should be chosen to have a hardness at least as great as the contact surfaces on the optical device 10 and substrate 12 (as well as on the cover 42 as described herein with reference to FIG. 7), whereby the hard particles 20 can pierce through any surface oxidation or residue to create a sound electrical contact with the various contact surfaces.

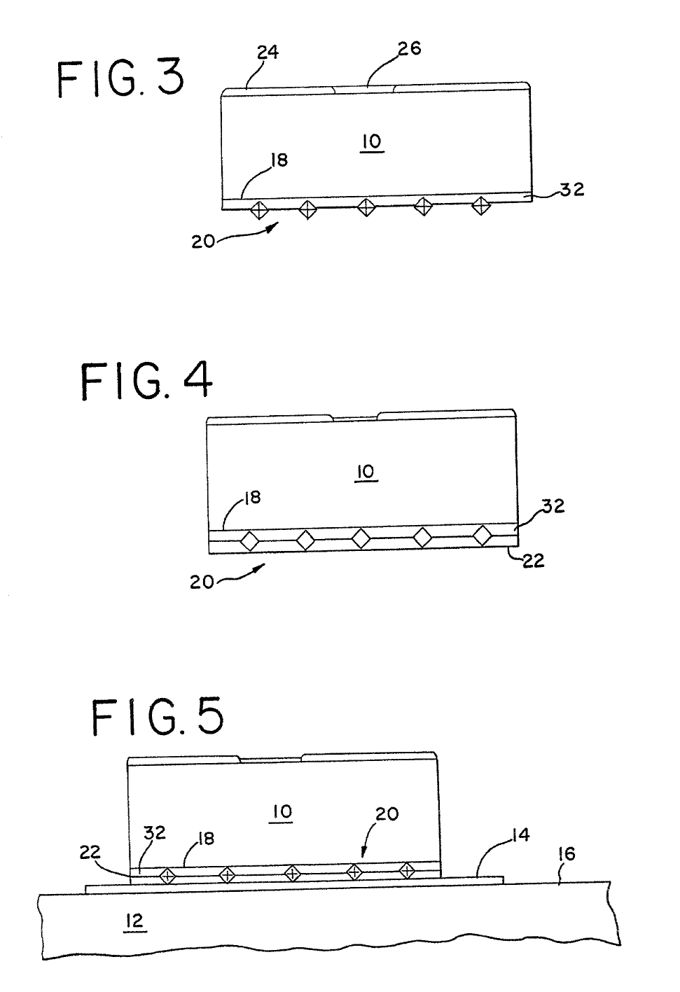

As illustrated in FIG. 3, once the optical device 10 has been compressed against support surface 34, a plurality of electrically conductive hard particles 20 is attached to the optical device 10 by adhering to the base surface 18 or by being at least partially embedded in the metal layer 32. Once the electrically conductive hard particles 20 are attached to the base surface 18 of the optical device 10, the optical device 10 may be maneuvered and positioned while the electrically conductive hard particles 20 remain securely attached to the base surface 18. Accordingly, the method of the invention is particularly adaptable to pick-and-place mounting technology. For example, a control arm can maneuver the optical device 10 to an appropriate position on the substrate 12 for attachment of the optical device 10.

After attaching the electrically conductive hard particles 20 to the base surface 18, in one embodiment of the invention, a layer of adhesive 22 is applied over the metal layer 32, as illustrated in FIG. 4. This material is preferably composed of any of the same adhesives as described earlier with reference to FIG. 1. In one embodiment of the invention, the optical device 10 may simply be brought into contact with a viscous liquid adhesive, such that a layer of adhesive adheres to the metal layer 32 and the electrically conductive hard particles 20. Alternatively, the adhesive layer 22 may be applied to the metal layer 32 by spreading a viscous adhesive material onto the metal layer 32. In yet another alternative, the adhesive layer 22 may be an adhesive tape that is applied to the metal layer 32. Further, the adhesive layer 22 may be applied to either the metal layer 32, an electrical contact on the substrate, or both.

Next, as illustrated in FIG. 5, the optical device 10 is positioned on an electrical contact land 14 overlying the substrate 12, such that the adhesive material 22, with suspended electrically conductive hard particles 20 therein, is positioned between the optical device 10 and the electrical contact land 14. When the optical device 10 is positioned on the electrical contact land 14, a compressive force in a direction generally normal to the surface 16 of the substrate 12 is applied. Under the compressive force, the electrically conductive hard particles 20 are at least partially embedded into the metal surface of the electrical contact land 14 and, if they have not already done so, into the metal layer 32 on the base surface 18 of the optical device 10. By firmly attaching the hard particles 20 to the metal layer 32 and to the contact land 14, an electrical contact is formed between the optical device 10 and the contact land 14.

Once a compressive bond has been formed between the optical device 10 and the electrical contact land 14, the adhesive layer 22 is hardened by either a self-hardening mechanism or by thermal or UV curing of the adhesive 22. The curing process drives off solvents and moisture from the adhesive material 22 and forms a hard, mechanical bond between the base surface 18 and the electrical contact land 14.

Preferably, the adhesive layer 22 is a non-electrically conductive adhesive material, for example, cyano acrylate, that sets very rapidly with or without the application of heat or other treatments. Alternatively, the adhesive layer 22 may be an ultraviolet-light (UV) curable polymer composition. Further, permanently hardenable adhesives, for example, a hot melt adhesive, or a polymerizable adhesive, may be used. In yet another alternative, the adhesive layer 22 may be a pressure-sensitive adhesive. Preferably, the adhesive 22 employed should have reduced levels of impurities that may adversely affect the component or the interconnection. In particular, sodium and chlorine ions are known to cause electrical devices, such as the optical device 10 to fail, and sodium ions, in particular, promote corrosion of electrical interconnections under humid conditions.

In another embodiment of the invention, the adhesive layer 22 may be applied to the electrical contact land 14 before positioning the optical device 10 in bonding position. The adhesive layer 22 may be applied to the substrate 12 as either a liquid or an adhesive tape. In one embodiment, the adhesive material 22 is uniformly spread across the substrate 12 and over the contact lands 14. Where a filler is used, it is preferred that the filler not contain particles larger than the electrically conductive hard particles 20.

In accordance with the invention, the adhesive layer 22 may also include an underfill material to enhance the integrity of the electrical contact. The underfill material may be dispensed around two adjacent sides of the optical device 10 and will flow by capillary action to fill any gaps between the base surface 18 and the contact land 14.

In a further embodiment of the invention, the electrically conductive hard particles 20 may be embedded in or attached to the contact land 14. In accordance with the previously described process, a soft metal layer is applied to the substrate 12. The soft metal is either applied over an existing metal contact land 14, or is used to form the contact land 14 itself. Compressive force is applied to adhere the conductive hard particles 20 to the soft metal layer. The electrically conductive hard particles 20 may also be provided in conjunction with a conventional solder bonding process to enhance the electrical contact between the optical device 10 and the substrate 12.

Alternatively, an adhesive film containing electrically conductive hard particles 20 may be applied to contact lands 14. Other methods for bonding optical devices 10 to the substrate 12 using hard particles 20 and adhesives 22 are further disclosed in U.S. patent application Ser. No. 09/812,140 entitled “Electrical Component Assembly and method of Fabrication,” filed Mar. 19, 2001, which is hereby incorporated herein by reference. This application further discloses methods for plating hard particles 20 onto substrates 12 using an electrolytic plating process, which process may also be used in conjunction with the present invention.

In another embodiment, the electrically conductive hard particles 20 are deposited on the contact lands 14 using a two-step electroless plating process. In the first plating step, metal and hard particle cores are co-deposited on the support surface 34. The metal is preferably nickel, although other metals can also be used. After co-depositing the metal and hard particle cores, a catalytic zinc solution is applied to activate the surfaces of the hard particle cores. A second metal layer is then plated over the hard particle cores. The second metal layer strongly adheres to the activated surfaces of the hard particle cores. Again, the preferred metal is nickel, although other metals can be used. The two-step electroless plating process is disclosed in commonly-assigned, co-pending patent application having Ser. No. 09/883,012 entitled “Electroless Process for the Preparation of Particle-Enhanced Electric Contact Surfaces,” filed Jun. 15, 2001, which is hereby incorporated herein by reference.

Further, the electrically conductive hard particles 20 may be applied using a stencil or screen printing process in which the hard particles 20 are entrained in a viscous liquid, for example, by the methods disclosed in PCT patent application serial No. ______ entitled “Method and Material for Printing Particle-Enhanced Electrical Contacts,” filed Oct. 24, 2001, which is hereby incorporated herein by reference. The stencil or screen is placed on the substrate 12 and the viscous liquid is applied to the surface 16 in surface regions exposed by the stencil or screen. Using any of the foregoing processes, the electrically conductive hard particles 20 can be attached to either the base surface 18 of the optical device 10, or to both the optical device 10 and to the contact land 14.

The incorporation of the electrically conductive hard particles 20 in the present invention advantageously enables the use of non-electrically conductive adhesives to form an electrical contact. Because the adhesive is not electrically conductive, there is no danger of shorting adjacent illuminating devices located on substrate 12. Further, to improve the thermal conductivity of the electrical contact, an adhesive with low heat resistance may be used.

In accordance with one embodiment of the invention, a wire bond 28 may be bonded to the bond pad 26 on the face surface 24 and to the metal lead 29, as shown in FIG. 1. The substrate 12, when populated with a plurality of optical devices 10, may be incorporated into an optical device module, for example, LED array module, for use as an illumination source. Such an array module will benefit from the bonding process of the invention. In particular, the individual LEDs may be tightly packed together, since the use of a non-electrically conductive adhesive removes the possibility of electrical shorts developing between adjacent illuminating devices.

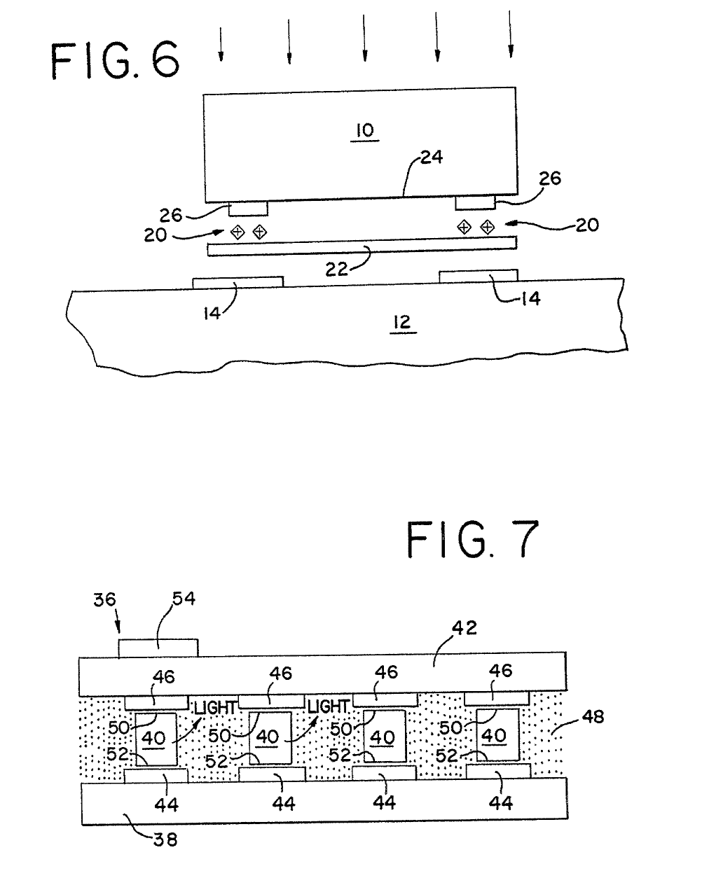

Although the foregoing inventive process is described with reference to a conventional chip mounting and wire bonding process, the invention is not limited to this process and may also be applied to the fabrication of flip-chip devices. FIG. 6 illustrates an exploded cross-sectional view of a flip-chip bonding process carried out in accordance with the invention. Bond pads 26 on the face surface 24 of the optical device 10 are aligned to a pair of electrical contact lands 14 on the substrate 12.

The bond pads 26 may be formed by any of a number of conventional flip-chip connection metalization structures, for example, ball bonding metals, solder bump metals, and controlled-collapsible-chip-connection (C4) metals. Further, using a standard metal deposition process, a soft metal may be applied to the surface of the bond pads 26 or to the contact lands 14, or both, to aid the adherence of the hard particles 20 to the contact metallization.

An electrical connection may be formed between the bond pads 26 and the contact lands 14 using any of the particle-enhanced bonding processes described above. Similar to the bonding processes described above, the adhesive layer 22 is applied to aid in the mechanical attachment of the optical device 10 to the substrate 12. In the case of flip-chip attachment, the adhesive layer 22 is one of the non-electrically conductive adhesive materials described above.

In accordance with another embodiment of the invention, the bonding process previously described may be applied to the face surface 24 of an optical device 10 and a transparent cover 42 positioned over an array of optical devices. FIG. 7 illustrates, in cross-section, an optical device module 36 arranged in accordance with the invention. The module 36 includes a substrate 38 with a plurality of optical devices 40 positioned thereon. The plurality of optical devices 40 may be individual optical devices 40 bonded to the contact lands 44 and contact pads 46 using the bonding process previously described. In another embodiment, the optical devices 40 may be an array of undiced optical devices 40 on a portion of a wafer. In this embodiment, the entire wafer-portion is bonded to the substrate 38 as a single unit by non-electrically-conductive adhesive 48 and each of the electrical contacts on the base surfaces 52 of the optical devices 40 (or face surfaces 24 if the optical devices 40 are flip-chips) is electrically connected to corresponding contact lands 44 on the substrate 38 by hard particles 20.

A transparent cover 42 is positioned opposite the substrate 38 and overlies the optical devices 40. The optical devices 40 are bonded to the contact lands 44 on the substrate 38 and to the contact pads 46 on the transparent cover 42. In an alternative embodiment, when flip-chip optical devices 40 are used, all electrical connections to the optical device 40 are made with the contact lands 44 on the substrate 38. Therefore, the cover 42 in such an embodiment need not have contact pads 46 for connection with the optical devices 40. An adhesive material 48 is positioned between the substrate 38 and the transparent cover 42, and may fill the regions not occupied by the optical devices 40 to seal the optical device module 36 between the substrate 38 and the cover 42. The adhesive material 48 may be transparent to light emitted or detected by the optical devices 40. The adhesive material 48 may also include an underfill material.

In the optical device module 36, the contact pads 46 are electrically attached to bond pads (not shown) on a face surface 50 of each optical device 40 and the contact lands 44 are bonded to a base surface 52 of each optical device 40. Although the device module 36 is illustrated in FIG. 7 as including an adhesive layer 48 generally distributed between the substrate 38 and the transparent cover 42, the adhesive material 48 may be limited to an area between the face surface 50 of the optical devices 40 and the transparent cover 42 and an area between the contact lands 44 on the substrate 38 and the base surface 52 of each optical device 40.

In one embodiment of the invention, where the optical devices 40 are illuminating devices, for example, LEDs, the contact pads 46 are formed of a material that is substantially transparent to the light emitted by the optical devices 40. For example, the contact pads 46 may be indium-tin-oxide or another electrically conductive material that is substantially transparent to the emitted light.

To enhance the illumination quality from the device module 36, in another embodiment of the invention, lenses, such as lens 54, may be positioned on the transparent cover 42 opposite one or more of the contact pads 46. The lens 54 may be positioned in spaced relationship with each optical device 40. Accordingly, the light emitted by the optical device 40 is focused by the lens 54. Alternatively, a single lens 54 may be positioned to focus the light of multiple optical devices 40. In such an embodiment, either the lens 54, the substrate 38, or both may be curved to augment the focal ability of the lens 54. Although the lens 54 is shown overlying a surface of the transparent cover 42, the lens 54 can also be positioned within an opening in the transparent cover 42. The positioning of the lens 54 in an opening in the transparent cover 42 may take place during a molding operation, in which the transparent cover 42 is molded, for example, from a polycarbonate material. In such a process, the lens 54 is firmly affixed to or within the transparent cover 42 during the molding process.

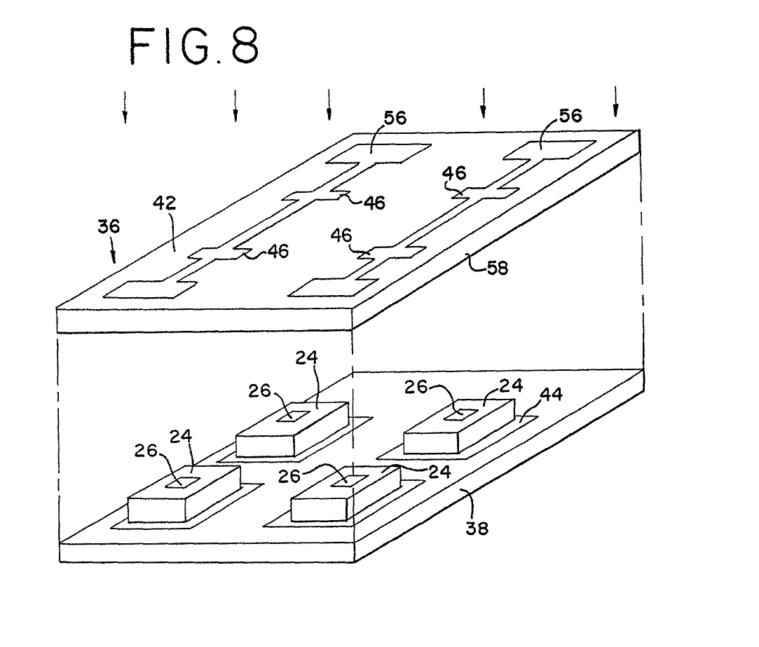

In an alternative embodiment of the invention, metal traces 56 may be positioned on an inner surface 58 of the transparent cover 42, as illustrated in FIG. 8. The metal traces 56 are positioned on the surface 58, such that when the transparent cover 42 is bonded to the optical devices 40, the metal traces 56 do not overlie substantial portions of the optical devices 40. When arranged, as illustrated in the assembly drawing of FIG. 8, the metal traces 56 may be any of a number of commonly used interconnect metals, for example, copper and aluminum.

To assemble the illuminating device module 36, after bonding the optical devices 40 to the substrate 38, as described above, a plurality of hard particles are positioned on either the bond pads 26 on the face surface 24, or on the contact pads 46, such that each contact pad or bond pad has at least one hard particle associated therewith. An adhesive is applied to either the face surface 24 of the optical devices 40 or the contact pads 46, and the contact pads 46 are brought into compressive contact with the bond pads 26. In this manner, electrical contacts between the contact pads 46 on the cover 42 and the optical devices 40, as well as the sealing of the module 36, may be made in a single step of pressing the cover 42 and the substrate 38 together, rather than the multiple steps of wire boding each of the bond pads 50 to a contact surface.

As referred to herein, the bond pads 26 can be any of a number of different contact structures for making electrical contact with the optical devices 40. For example, the bond pads 26 may be stud-bumped contacts as commonly used in surface mount devices. Further, the bond pads 26 may be, for example, C4 contacts or ball grid array contacts.

The transparent cover 42 may be fabricated from any material that is substantially transparent to the light emitted or detected by the optical devices 40. For example, the transparent cover 42 may be, for example, a glass material, a plastic, or a ceramic. In accordance with the invention, the selection of the particular material for the transparent cover 42 is dependent upon the particular wavelength of light emitted or detected by the optical devices 40. For example, some optical devices 40 are designed to emit or receive visible light, infrared light, or ultra-violet light. In one embodiment of the invention, where the optical devices 40 are LEDs that emit visible light, the transparent cover 42 is fabricated from molded polycarbonate.

Thus, it is apparent that there has been described, in accordance with the invention, an optical device module and fabrication method that fully provides the advantages set forth above. Although the invention has been described and illustrated with reference to specific illustrative embodiments thereof, it is not intended that the invention be limited to those illustrative embodiments. Those skilled in the art will recognize that variations and modifications can be made without departing from the spirit of the invention. For example, optical sensors can be combined with LEDs within the same module. Further, numerous additional materials can be included to fabricate additional components of a device module, for example, side moldings and electrical interconnections. It is therefore intended that all such variations and modifications be included within the invention as fall within the scope of the appended claims and equivalents thereof.

What is claimed is:

1. A process for fabricating an optical device module comprising the steps of:
providing an optical device having an electrically conductive base surface;
providing a mounting substrate having an electrical contact land upon a surface thereof;
attaching a plurality of electrically conductive hard particles to at least one of the base surface and the electrical contact land;
disposing an adhesive between the contact land and the base surface;
attaching the base surface of the optical device to the contact land; and
curing the adhesive, wherein
an electrical and mechanical connection is formed between the optical device and the mounting substrate.

2. The process as described in claim 1, wherein the step of attaching the optical device to the electrical contact land further comprises applying a compressive force generally normal to an interface between the optical device and the mounting substrate, wherein
each of the hard particles has a hardness at least as great as at least one of the base surface and the contact land, and
the hard particles pierce through the adhesive and into at least one of the base surface and the contact land.

3. The process as described in claim 1, wherein the step of attaching a plurality of electrically conductive particles further comprises:
placing the base surface of the optical device in contact with the hard particles; and
applying a compressive force, wherein
the hard particles adhere to the base surface.

4. The process as described in claim 1, wherein the optical device further comprises:
a face surface opposite the base surface; and
a bond pad residing on the face surface; and wherein
the process further comprises:
forming an electrical connection with the bond pad.

5. The process as described in claim 4, wherein the step of forming an electrical connection with the bond pad further comprises:
bonding a first end of a wire bonded to the bond pad; and
bonding a second end of the wire to a second electrical contact land on the mounting substrate.

6. The process as described in claim 4, wherein the process further comprises providing a cover, wherein
the cover is substantially transparent to light emitted or detected by the optical device, and wherein the cover further comprises:
an inner surface; and
an electrically conductive layer disposed on the inner surface; and wherein
the step of forming an electrical connection with the bond pad further comprises electrically connecting the bond pad to the conductive layer.

7. The process as described in claim 6, wherein the conductive layer comprises a patterned conductive layer.

8. The process as described in claim 6, wherein the step of electrically connecting the bond pad to the electrically conductive layer further comprises:
attaching a second plurality of electrically conductive hard particles to at least a portion of at least one of the bond pad and the conductive layer;
applying a layer of adhesive to at least one of the face surface of the optical device and the inner surface of the cover, wherein
the adhesive is non-electrically-conductive and substantially transparent to the light emitted or detected by the optical device;
bringing the bond pad and the conductive layer together to form an interface; and
applying compressive force in a direction generally normal to the interface, wherein
the second plurality of hard particles pierce at least one of the bond pad and the conductive layer.

9. A process for fabricating an optical device module comprising the steps of:
providing at least a portion of a wafer comprising a plurality of undiced optical devices, wherein
each of the optical devices has an electrically conductive surface;
providing a mounting substrate having a plurality of electrical contact lands upon a surface thereof;
attaching a plurality of electrically conductive hard particles to at least one of the electrically conductive surfaces and the electrical contact lands;
disposing an adhesive between at least the contact lands and the electrically conductive surfaces;
attaching each of the electrically conductive surfaces of the optical devices to a respective one of the contact lands; and
curing the adhesive, wherein
an electrical and mechanical connection is formed between the optical devices on the wafer and the mounting substrate.

10. A process for fabricating an optical device module comprising the steps of:
providing an optical device having an electrically conductive base surface;
providing a mounting substrate having an electrical contact land upon a surface thereof;
picking up the optical device;
pressing the base surface of the optical device into a reservoir of electrically conductive hard particles, wherein
a plurality of the electrically conductive hard particles adhere to the base surface of the optical device;
applying an adhesive to at least one of the contact land and the base surface;
placing the optical device on the contact land, wherein the hard particles on the base surface are in contact with the contact land; and
curing the adhesive, wherein
an electrical and mechanical connection is formed between the optical device and the mounting substrate.

11. The process as described in claim 10, wherein
the base surface comprises a layer of metal; and
the plurality of hard particles becomes partially embedded in the layer of metal when the base surface of the optical device is pressed into the reservoir.

12. The process as described in claim 10, wherein the step of placing the optical device on the electrical contact land further comprises:
applying a compressive force generally normal to an interface between the optical device and the mounting substrate, wherein
each of the hard particles has a hardness at least as great as at least one of the base surface and the contact land, and
the hard particles pierce through the adhesive and into at least one of the base surface and the contact land.

13. A process for fabricating an optical device module comprising:
providing a mounting substrate having a plurality of optical devices mounted thereon, wherein
each of the plurality of optical devices has a bond pad on a face surface thereof,
providing a cover, wherein
the cover is substantially transparent to light emitted or detected by the plurality of optical devices, and wherein the cover further comprises:
an inner surface; and
a plurality of electrically conductive contact pads disposed on the inner surface, wherein
each of the contact pads corresponds to a respective one of the bond pads of the optical devices;
positioning a plurality of electrically conductive hard particles on at least one of each of the contact pads and each of the bond pads,
applying a layer of adhesive on at least one of the face surface of each of the optical devices and each of the contact pads, wherein
the adhesive is substantially transparent to the light emitted or detected by the plurality of optical devices; and
bonding each of the contact pads to the respective bond pads, wherein
an electrical and mechanical connection is formed between the optical device and the mounting substrate.

14. The process as described in claim 13, wherein the plurality of optical devices comprises at least a portion of a wafer comprising a plurality of undiced optical devices.

15. The process as described in claim 13, wherein
a plurality of conductive traces are further disposed on the inner surface of the cover,
each of the conductive traces is connected to at least one of the contact pads, respectively, and
the conductive traces are positioned such that when the contact pads are bonded to the bond pads, the conductive traces do not directly overly the optical devices.

16. The process as described in claim 15, wherein the conductive traces comprise a metal selected from a group comprising: copper, gold, and aluminum.

17. The process as described in claim 15, wherein the contact pads and the conductive traces together further constitute a patterned electrically conductive layer disposed on the inner surface of the cover.

18. The process as described in claim 13, wherein
the step of providing a cover comprises providing a cover having a plurality of lenses, wherein
each of the lenses is positioned apart from the inner surface in a spaced relationship opposite at least one of the contact pads, respectively, and
each of the lenses corresponds to at least one of the optical devices respectively.

19. The process as described in claim 18, wherein the cover further contains a plurality of openings, and
each of the lenses is mounted within a respective one of the openings in the cover.

20. The process as described in claim 13, wherein the cover comprises a molded polycarbonate.

21. A process for fabricating an optical device module comprising the steps of:
providing a mounting substrate comprising:
a first electrical contact land on a surface of the mounting substrate; and
a second electrical contact land on the surface of the mounting substrate;
providing an optical device comprising:
a face surface;
a first bond pad on the face surface;
a second bond pad on the face surface;
adhering a plurality of electrically conductive hard particles on at least one of the first and second contact lands and the first and second bond pads;
positioning an adhesive between the mounting substrate and the optical device;
forming a first electrical connection between the first contact land and the first bond pad and a second electrical connection between the second contact land and the second bond pad.

22. The process as described in claim 21, wherein the step of forming further comprises applying a compressive force generally normal to an interface between the optical device and the mounting substrate, wherein
each of the hard particles has a hardness at least as great as at least one of the first and second contact lands and the first and second bond pads, and
the hard particles pierce through the adhesive and into at least one of the first and second contact lands and the first and second bond pads.

23. The process as described in claim 21, wherein the step of positioning the plurality of electrically conductive hard particles comprises plating the hard particles on at least one of the first and second contact lands and the first and second bond pads.

24. The process as described in claim 1, 9, 10, 13, or 21, wherein the adhesive comprises a non-electrically-conductive adhesive.

25. The process as described in claim 24, wherein the non-electrically-conductive adhesive comprises an adhesive selected from a group comprising: an epoxy, cyanoacrylate, a polyurethane-based adhesive, and an UV-curable adhesive.

26. The process as described in claim 1, 8, 9, 10, 13, or 21, wherein each of the hard particles comprises a hard core surrounded by a metal layer.

27. The process as described in claim 26, wherein the hard core comprises a non-electrically-conductive particle core comprised of at least one of the following: diamond, garnet, ceramic, oxides, silicides, silicates, carbides, carbonates, borides, boron fibers, and nitrides.

28. The process as described in claim 26, wherein the metal layer comprises at least one of the following: copper, aluminum, nickel, tin, bismuth, silver, gold, platinum, palladium, lithium, beryllium, boron, sodium, magnesium, potassium, calcium, gallium, germanium, rubidium, strontium, indium, antimony, cesium, and barium, and alloys and intermetallics of these metals.

29. The process as described in claim 1, 8, 9, 10, 13, or 21, wherein the hard particles comprise metal particles comprised of at least one of the following: copper, aluminum, nickel, tin, bismuth, silver, gold, platinum, palladium, lithium, beryllium, boron, sodium, magnesium, potassium, calcium, gallium, germanium, rubidium, strontium, indium, antimony, cesium, and barium, and alloys and intermetallics of these metals.

30. The process as described in claim 6 or 17, wherein the electrically conductive layer comprises a material that is substantially transparent to the light emitted or detected by the optical device.

31. The process as described in claim 30, wherein the electrically conductive layer comprises indium-tin-oxide.

32. The process as described in claim 1, 10, or 21, wherein the optical device comprises at least one of the following: a light emitting diode, an optical sensor device, and a photosensor device.

33. The process as described in claim 9 or 13, wherein the optical devices comprise at least one of the following: a light emitting diode, an optical sensor device, and a photosensor device.

34. The process as described in claim 8, wherein the step of applying a layer of adhesive further comprises disposing the adhesive between the cover and the mounting surface, wherein the adhesive envelopes the optical device, fills any empty space between the cover and the mounting substrate, and mechanically connects the cover to the mounting substrate.

35. The process as described in claim 13, wherein the step of applying a layer of adhesive further comprises disposing the adhesive between the cover and the mounting surface, wherein the adhesive envelopes each of the plurality of optical devices, fills any empty space between the cover and the mounting substrate, and mechanically connects the cover to the mounting substrate.

36. The process as described in claim 5 or 21, further comprising:
positioning a cover over the optical device and the mounting surface, wherein
the cover is substantially transparent to light emitted or detected by the optical device;
disposing an adhesive between the cover and the mounting surface, wherein
the adhesive is non-electrically-conductive and is substantially transparent to light emitted or detected by the optical device; and
the adhesive envelopes the optical device and fills any empty space between the cover and the mounting substrate;
applying a compressive force normal to an interface between the cover, the adhesive, and the mounting surface; and
curing the adhesive, wherein
the adhesive mechanically connects the cover to the mounting substrate.

37. The process as described in claim 36, wherein
the step of providing a cover comprises providing a cover having a lens, wherein
the lenses is positioned corresponding to and spaced apart from the optical device.

38. The process as described in claim 37, wherein the cover further contains an opening, and
the lens is mounted within the opening in the cover.

39. The process as described in claim 37, wherein the cover comprises a molded polycarbonate.

40. An optical device module comprising:
a mounting substrate having a electrical contact land;
an optical device having an electrically conductive base surface, wherein
the base surface corresponds to and is aligned with the contact land;
a plurality of electrically conductive hard particles disposed between and in contact with the base surface and the contact land, wherein
the hard particles provide an electrical connection between the base surface and the contact land;
a layer of adhesive disposed between the base surface and the contact land, wherein
the adhesive envelopes the hard particles and provides a mechanical connection between the optical device and the mounting substrate.

41. An optical device module comprising:
a mounting substrate further comprising:
a first electrical contact land on a surface of the mounting substrate;
a second electrical contact land on the surface of the mounting substrate;
an optical device further comprising:
a face surface;
a first bond pad on the face surface; and
a second bond pad on the face surface; wherein
the first contact land corresponds to and is aligned with the first bond pad and the second contact land corresponds to and is aligned with the second bond pad;
a plurality of electrically conductive hard particles disposed between and in contact with the first and second bond pads and the first and second contact lands, wherein
the hard particles provide an electrical connection between the first contact land and the first bond pad and between the second contact land the second bond pad;
a layer of adhesive disposed between at least the first and second bond pads and first and second contact lands, wherein
the adhesive envelopes the hard particles and provides a mechanical connection between the optical device and the mounting substrate.

42. An optical device module comprising:
a mounting substrate having a plurality of optical devices positioned thereon, wherein each optical device further comprises:
a face surface; and
a bond pad on the face surface;
a cover further comprising:
an inner surface; and
a plurality of electrically conductive contact pads disposed on the inner surface, wherein
each contact pad corresponds to and is aligned with a respective bond pad on a respective face surface; and
the cover is substantially transparent to light emitted or detected by the plurality of optical devices;
a plurality of electrically conductive hard particles disposed between and in contact with each contact pad and the respective bond pad, wherein
the hard particles provide an electrical connection between each electrical contact pad and the respective bond pad; and
a layer of adhesive disposed between each contact pad and the respective face surface, wherein
the adhesive is substantially transparent to the light emitted or detected by each of the optical devices; and
the adhesive envelopes the hard particles and provides a mechanical connection between the face surface of each optical device and the cover.

43. The optical device module as described in claim 40, wherein the optical device further comprises:
a face surface opposite the base surface; and
a bond pad residing on the face surface;
the mounting substrate further comprises a second electrical contact land; and
the optical device module further comprises a wire bonded at a first end to the bond pad and bonded at a second end to the second contact land, wherein
an electrical connection is formed between the bond pad and the second contact land.

44. The optical device module as described in claim 40, wherein the optical device further comprises:
a face surface opposite the base surface; and
a bond pad residing on the face surface; and wherein
the optical device module further comprises:
a cover, wherein
the cover is substantially transparent to light emitted or detected by the optical device, and wherein the cover further comprises:
an inner surface; and
an electrically conductive layer disposed on the inner surface;
a second plurality of electrically conductive hard particles disposed between and in contact with the bond pad and the conductive layer, wherein
the hard particles provide an electrical connection between the bond pad and the conductive layer; and
a second layer of adhesive disposed between at least the bond pad and the conductive layer, wherein
the second layer of adhesive is non-electrically-conductive and substantially transparent to the light emitted or detected by the optical device; and
the second layer of adhesive envelopes the second plurality of hard particles and provides a mechanical connection between the face surface of the optical device and the cover.

45. The optical device module as described in claim 41 or 43, further comprising a cover, wherein
the cover is substantially transparent to light emitted or detected by the optical device; and
a second layer of adhesive disposed between the cover and the mounting surface, wherein
the second layer of adhesive is non-electrically-conductive and is substantially transparent to light emitted or detected by the optical device;
the second layer of adhesive envelopes the optical device and fills any empty space between the cover and the mounting substrate; and
the second layer of adhesive mechanically connects the cover to the mounting substrate.

46. The optical device module as described in claim 44, wherein the second layer of adhesive envelopes the optical device and fills any empty space between the cover and the mounting substrate.

47. The optical device module as described in claim 42, further comprising a plurality of conductive traces, wherein each of the conductive traces is:
electrically connected to at least one of the contact pads, respectively; and
positioned such that the conductive traces do not directly overly the optical devices.

48. The optical device module as described in claim 47, wherein the conductive traces comprise a metal selected from a group comprising: copper, gold, and aluminum.

49. The optical device module as described in claim 47, wherein the contact pads and the conductive traces together further constitute a patterned electrically conductive layer disposed on the inner surface of the cover.

50. The optical device module as described in claim 44 or 49, wherein the electrically conductive is substantially transparent to light emitted or detected by the optical devices.

51. The optical device module as described in claim 50, wherein the electrically conductive layer comprises indium-tin-oxide.

52. The optical device module as described in claim 44, wherein the electrically conductive layer comprises a patterned electrically conductive layer.

53. The optical device module as described in claim 40, 41, or 42, wherein the adhesive comprises a non-electrically-conductive adhesive.

54. The optical device module as described in claim 53, wherein the non-electrically-conductive adhesive comprises an adhesive selected from a group comprising: an epoxy, cyanoacrylate, a polyurethane-based adhesive, and an UV-curable adhesive.

55. The optical device module as described in claim 44, wherein the second layer of adhesive comprises an adhesive selected from a group comprising: an epoxy, cyanoacrylate, a polyurethane-based adhesive, and an UV-curable adhesive.

56. The optical device module as described in claim 45, wherein the second layer of adhesive comprises an adhesive selected from a group comprising: an epoxy, cyanoacrylate, a polyurethane-based adhesive, and an UV-curable adhesive.

57. The optical device module as described in claim 40, 41, 42, or 44, wherein each of the hard particles comprises a hard core surrounded by a metal layer.

58. The optical device module as described in claim 57, wherein the hard core comprises a non-electrically-conductive particle core comprised of at least one of the following: diamond, garnet, ceramic, oxides, silicides, silicates, carbides, carbonates, borides, boron fibers, and nitrides.

59. The optical device module as described in claim 57, wherein the metal layer comprises at least one of the following: copper, aluminum, nickel, tin, bismuth, silver, gold, platinum, palladium, lithium, beryllium, boron, sodium, magnesium, potassium, calcium, gallium, germanium, rubidium, strontium, indium, antimony, cesium, and barium, and alloys and intermetallics of these metals.

60. The optical device module as described in claim 40, 41, 42, or 44 wherein the hard particles comprise metal particles comprised of at least one of the following: copper, aluminum, nickel, tin, bismuth, silver, gold, platinum, palladium, lithium, beryllium, boron, sodium, magnesium, potassium, calcium, gallium, germanium, rubidium, strontium, indium, antimony, cesium, and barium, and alloys and intermetallics of these metals.

61. The optical device module as described in claim 40 or 41, wherein the optical device comprises at least one of the following: a light emitting diode, an optical sensor device, and a photosensor device.

62. The optical device module as described in claim 42, wherein the optical devices comprise at least one of the following: a light emitting diode, an optical sensor device, and a photosensor device.

63. The optical device module as described in claim 45, wherein the cover further comprises a lens positioned corresponding to and spaced apart from the optical device.

64. The optical device module as described in claim 63, wherein the cover further contains an opening, and
the lens is mounted within the opening in the cover.

65. The optical device module as described in claim 42, wherein the cover further comprises a plurality of lenses, wherein
each of the lenses is positioned apart from the inner surface in a spaced relationship opposite at least one of the contact pads, respectively, and
each of the lenses corresponds to at least one of the optical devices, respectively.

66. The optical device module as described in claim 65, wherein
the cover further contains a plurality of openings; and
each of the lenses is mounted within a respective one of the openings in the cover.

67. The optical device module as described in claim 42, wherein the cover comprises a molded polycarbonate material.

68. The optical device module as described in claim 45, wherein the cover comprises a molded polycarbonate material.

69. The optical device module as described in claim 42, wherein the plurality of optical devices comprises at least a portion of a wafer comprising a plurality of undiced optical devices.
